(19) United States
(12) Patent Application Publication
(10) Pub. No.: US 2008/0186960 A1
(43) Pub. Date: Aug. 7, 2008

(54) SYSTEM AND METHOD OF CONTROLLING MEDIA STREAMS IN AN ELECTRONIC DEVICE

(75) Inventors: Michael Kocheisen, Sunnyvale, CA (US); Lars Rehder, San Bruno, CA (US); Jianfeng Wu, Nanjing, Jiangsu (CN); Jeff Parrish, Los Altos, CA (US)

Correspondence Address: BERRY & ASSOCIATES P.C., 9255 SUNSET BOULEVARD, SUITE 810, LOS ANGELES, CA, 90069, US

(73) Assignee: ACCESS SYSTEMS AMERICAS, INC., Sunnyvale, CA (US)

(21) Appl. No.: 12/025,053

(22) Filed: Feb. 4, 2008

Related U.S. Application Data
(60) Provisional application No. 60/888,524, filed on Feb. 6, 2007.

(51) Int. Cl. H04L 12/50

(52) U.S. Cl. 370/359

(57) ABSTRACT

The present invention provides a method of controlling media streams in an electronic device that includes receiving an input stream from a plurality of applications executed on the electronic device outside of an execution thread of any of the plurality of applications and routing each of the input streams to an output device according to a set of preconfigured rules. In a second aspect, the present invention also provides an electronic device that includes a plurality of output device components and a processor that is adapted to execute 1) a plurality of applications producing streams of data, and 2) a mediator that is coupled to each of the output devices adapted to receive the data streams from each of a plurality of applications and route the data streams from the plurality of applications to one or more of the output devices according to a set of preconfigured rules.

### CLAIM OF PRIORITY

This application claims the benefit under 35 U.S.C. §119(e) of U.S. Provisional Patent Application Ser. No. 60/888,524, entitled “System and Method for Dynamically Mixing and Routing Media Streams On A Mobile Device Based On Flexible Rules That Can Be Updated Remotely”, filed on Feb. 6, 2007, which is also expressly incorporated by reference herein in its entirety.

### BACKGROUND OF THE INVENTION

1) Field of the Invention

The present invention pertains to electronic devices, and more particularly to a system and method for controlling media streams generated or received in such devices based on preconfigured rules.

2) Background

Electronic devices, such as mobile devices (e.g., personal digital assistants (PDAs), cell phones, portable computers, etc.) as well as other client devices that have embedded computing ability may include multiple input and output device components for receiving and outputting streams data (such as audio or video data streams). To provide suitable audio/video output to the user, audio sounds and video are usually mixed and routed to and from the appropriate input/output devices. By way of example, an alarm may be routed to a speaker of the electronic device, whereas a video/audio of a slideshow presentation application may be routed to a display screen. However, when the number of input/output devices increases, routing may become a non-trivial operation.

Additional factors can complicated or magnify the problem of providing appropriate routing of data streams between input and output devices in an electronic device. Among such factors are: the intermittent accessibility of certain devices, such as removable Bluetooth accessories; simultaneous production of media streams by multiple applications, which may require mixing and/or arbitration; the need to adapt applications for new input/output accessory devices as they are developed; and the requirement to prevent and limit the reproduction and use of protected content (digital rights management).

Due to these problems and additional factors, electronic devices may fall short of supporting all possible media routing scenarios. For example, an electronic device may only execute a specific application and limit user options in the user interface, or may provide for only one media stream playback at any given time.

What is therefore needed is a more general system and method for routing data from and to input/output devices in an electronic device that can flexibly handle routing to any number of devices, intermittent or otherwise, and any number of simultaneous data streams.

### SUMMARY OF THE INVENTION

In a first aspect, the present invention provides a method of controlling media streams in an electronic device that includes: (1) receiving an input stream from each of a plurality of applications executed on the electronic device outside of an execution thread of any of the plurality of applications and (2) routing each of the input streams to an output device according to a set of preconfigured rules.

In a second aspect, the present invention provides an electronic device that includes a plurality of output devices, and a processor that is adapted to execute: 1) a plurality of applications, each of the plurality of applications being adapted to produce a stream of data, and 2) a mediator that is coupled to each of the output devices, the mediator process being further adapted to: i) receive the data streams from each of a plurality of applications and ii) route the data streams from the plurality of applications to one or more of the plurality of output devices according to a set of preconfigured rules.

Additional features and advantages of the invention will be set forth in the description which follows, and in part will be obvious from the description, or may be learned by practice of the invention.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram of an exemplary electronic device.

FIG. 2 is a block diagram of a high-level implementation of a rule-based mediator according to an embodiment of the present invention.

FIG. 3 is a flow diagram showing an exemplary application of rules-based routing and conflict resolution by the mediator according to an embodiment of the present invention.

FIG. 4 is a block diagram of an exemplary software architecture implementation of the system and method of the present invention.

### DETAILED DESCRIPTION

Conventionally, a program application that generates a media stream, such as a media player, also provides instructions as to which device the stream (‘input stream’) should be output from (e.g., speaker, display screen) and other information which may indicate other applications to be invoked or blocked, other streams to be mixed, volumes to be set, etc. This application-based approach is workable when a small number of applications and devices are to be operated simultaneously. However, in newer electronic devices numerous applications may generate input streams simultaneously which may be routed to an ever-larger number of output devices. Thus, in newer models, the application-based approach is sub-optimal because the tasks of routing numerous input streams to appropriate output devices and, equally importantly, of resolving conflicts that may occur among applications as they ‘compete’ for use of the output devices, become too difficult for individual applications to perform.

The present invention provides a method and system of controlling the output of signals in an electronic device that replaces the application-based approach by establishing a mediator that runs separately (e.g., outside of the execution thread) from the applications and that performs the routing functions previously managed by the applications. More specifically, the mediator receives input streams from a plurality of applications and may perform actions on the input streams such as routing, mixing, modifying and blocking according to a set of stored preconfigured rules. The systems and methods of the present invention provide the advantages that device manufacturers can customize their devices since routing becomes automatic, and application developers can save development time as they no longer need to include functionality for routing, mixing, modifying, blocking, etc.

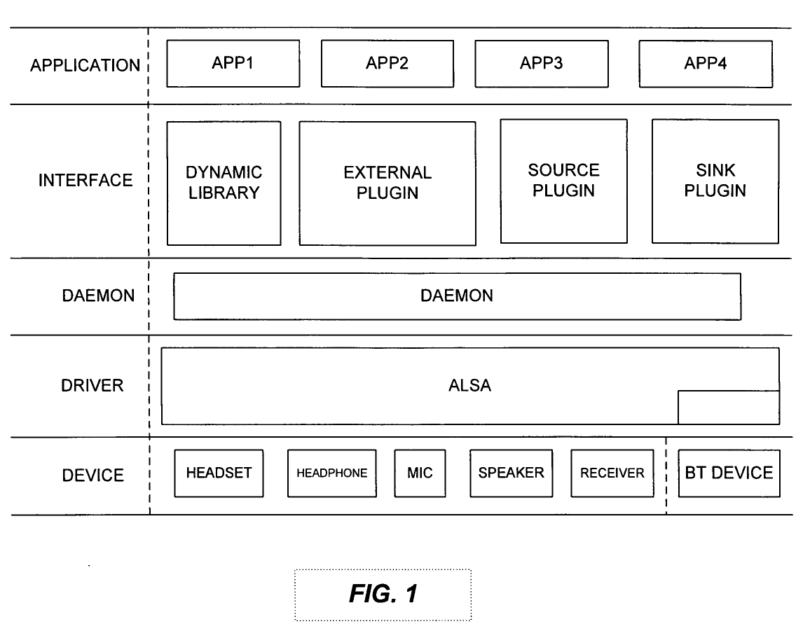

FIG. 1 is a block diagram of an exemplary electronic device 100, which may comprise a mobile device such as a portable computer, a personal digital assistant (PDA), an enhanced cell phone, an ‘information appliance’ constituting an electronic device having a limited manual interface such as a television, set top box or navigation device, or any other device having an embedded processor and the ability to communicate electrical signals (wired or wirelessly). The electronic device 100 includes a processor 102 adapted to run an operating system platform and application programs. The processor 102 is also adapted to control the other components of the electronic device 100 about to be discussed. An internal memory unit (hereinafter termed ‘memory unit A’) 104, which may be implemented as an internal memory card (e.g., SIM card), for example, may include read-only-memory (ROM) to store system-critical files and random access memory (RAM) to store other files as needed (see FIG. 1). Other components of the electronic device 100 are coupled to the processor 102 via a system bus 108.

The electronic device 100 also includes a number of additional components that are designed to provide information to the electronic device 100 (‘input devices’), to output information from the electronic device 100 (‘output devices’) or to perform both functions (‘I/O devices’). For instance, the electronic device 100 may include a microphone 112 and a camera 114 to obtain audio or graphics (picture, photo, video etc.) data. The electronic device 100 may also include corresponding output devices for sound and graphics data in the form of a speaker 116 and a display screen 118. In some embodiments, the display screen 118 (or a portion thereof) may be touch sensitive. In such embodiments, the display screen 118 may be considered an I/O device. Strictly speaking, both the internal memory 104 and any other memory device to which the processor may write data, such as a removable card drive 120, may be considered output devices when they store streams of data. As an example, a sound stream input to the electronic device 100 via the microphone 112 may be received by the processor 102 and then recorded using a memory device 104, 120.

The electronic device 100 also employs I/O devices particularly for purposes of communication (transmission and reception). In one or more embodiments, the electronic device 100 may include a transceiver 122 that is adapted to transmit and receive wireless signals over one or more frequency bands. In some embodiments, the transceiver 122 may have Bluetooth capability and may communicate with an external Bluetooth device 124 over the frequency band set by the Bluetooth protocol. The Bluetooth device 124 may comprise a head-set, car kit, or other known Bluetooth-capable devices. During communication between the transceiver 122 and the Bluetooth device 124 each perform the function of an input device and output device with respect to the electronic device 100.

Similarly, the electronic device 100 may also include a number of embedded ports 126, 128, 130 adapted to receive or communicate with external devices (not shown). In some embodiments, the ports 126, 128, 130 are coupled to the processor 102 via a hardware interface 132 that couples directly to the system bus 106. In an exemplary embodiment, the ports may take the form of a headset jack port 126 adapted to receive a standard headset jack, a headphone jack port 128 adapted to receive a standard headphone jack, and an IR port 130, which may communicate via infrared signals devices located proximate to the electronic device 100 having a corresponding IR port.

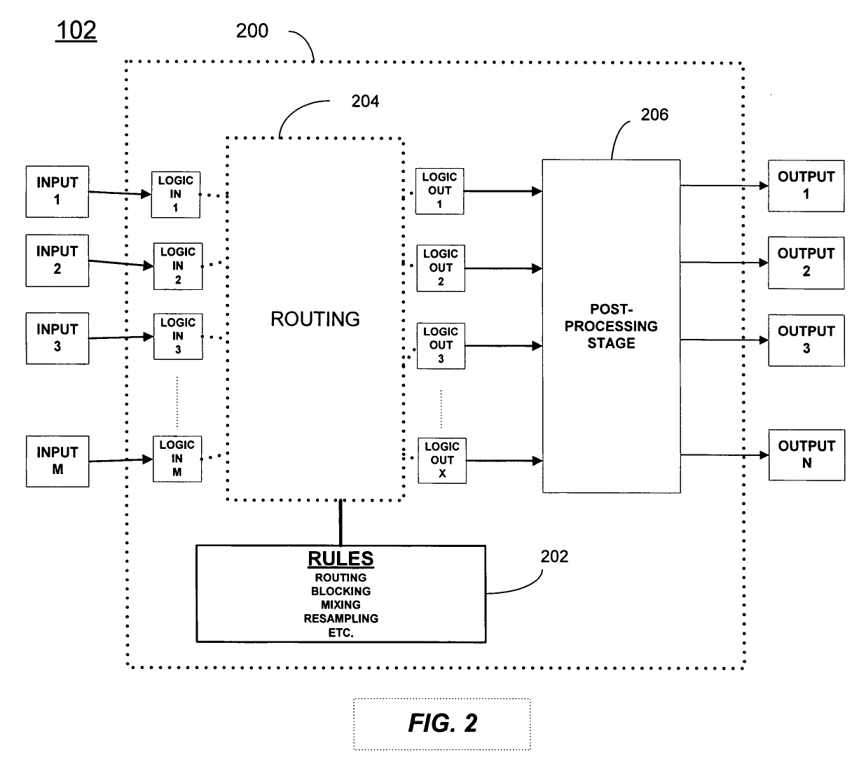

The processor 102 is charged with the task of coordinating the flow of data streams from the input devices to the output devices (going forward I/O devices are considered as either input devices or output devices at a given time depending on the capacity in which they are acting). FIG. 2 is a block diagram of a high-level implementation of a rule-based mediator executed by the processor according to the present invention. As shown, a series of exemplary inputs Input 1, Input 2, Input 3 . . . Input M lead into the mediator 200, and a series of exemplary outputs, Output 1, Output 2, Output 3 . . . Output N lead out of the mediator 200, where M and N can be any whole number and may be the same or different. It is important to note that the inputs Input 1, Input 2, Input 3 . . . Input M do not necessarily, and in most case will not, refer to input devices. Rather, each Input 1, Input 2, Input 3 . . . Input M represents a data stream that has been generated by an application running on processor 102.

The mediator 200 obtains data streams Input 1, Input 2, Input 3 . . . Input M at corresponding logical inputs Logic In 1, Logic In 2, Logic In 3 . . . Logic In M. The mediator then determines how to route each input stream by applying certain preset, preconfigured rules 202. The rules, which may be implemented using tables stored in a database or in an XML file, include a set of instructions (of arbitrary complexity) that govern not only where to send input streams, but also how to resolve conflicts between and prioritize various input streams, and when to block or mute an input stream based on certain criteria. The rules may be added, removed or changed by modifying the rule table(s) (which may require authentication).

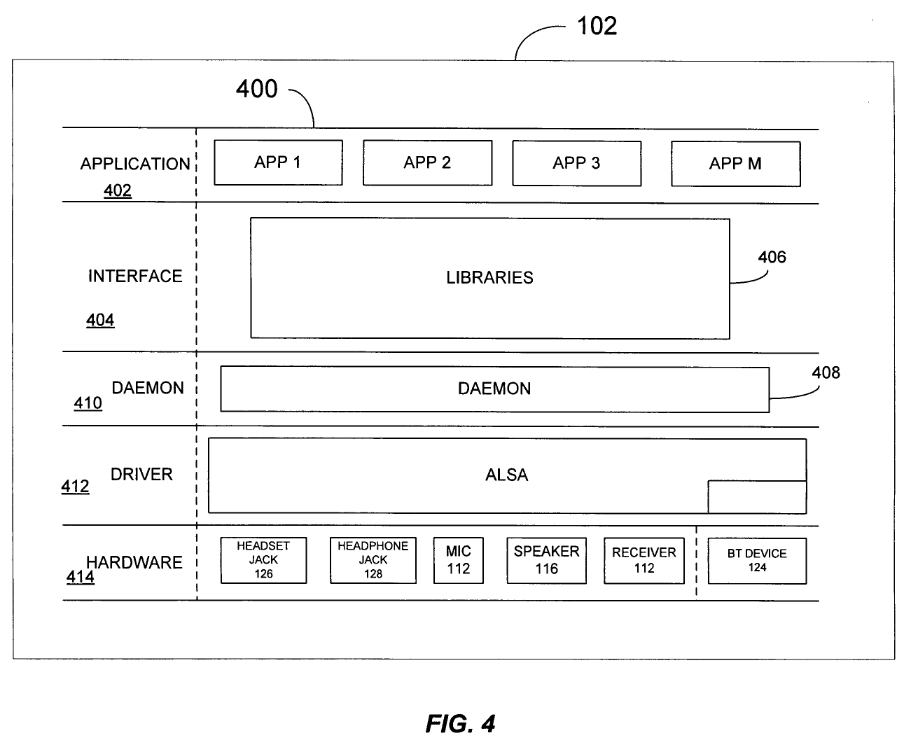

From Logic In 1, Logic In 2, Login In 3 . . . Login In M, the data streams are fed through a logical router 204 and are blocked or routed to one (or more in the case of a split stream) of the logical output Logic Out 1, Logic Out 2, Logic Out 3, . . . Logic Out X. It is emphasized that the particular Logical Output that is routed is governed by the rules 202 and that there need not be a one-to-one correspondence between the numbers of inputs and outputs. For example, the router 204 may split the input data streams input at Logic In 2 into two data streams, one of which is routed to Logic Out 2 and the other of which is routed to Logic Out 5 (not shown). Once data streams have been routed to the logical outputs Logic Out 1, Logic Out 2, Logic Out 3 . . . Logic Out X, one or more of the streams may be adjusted in post-processing stage 206 where the streams may be re-sampled to match certain frequencies prior to mixing, increased or decreased in volume, and/or mixed before being delivered to final outputs Output 1, Output 2, Output 3 . . . Output N. It is noted that the number of final outputs (N) and the number of logical outputs (X) may be different. For example, several data streams output from the logical outputs Logic Out 1, Logic Out 2, Logic Out 3 . . . Logic Out X may be mixed together, reducing the number of data streams finally output. Further details concerning the mediator 200 and an example of how it may be implemented are discussed below with reference to FIG. 4.

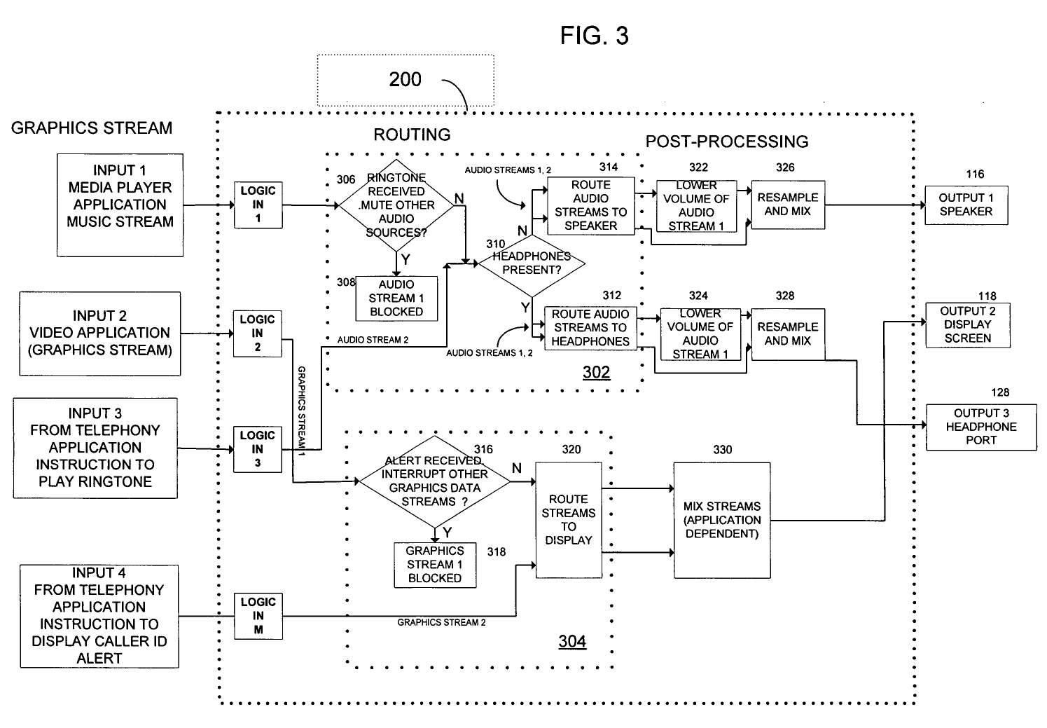

FIG. 3 is a flow diagram showing an exemplary application of rules-based routing and conflict resolution by the mediator 200 according to an embodiment of the present invention. In the depicted example, Input 1 (audio stream 1) represents an audio stream generated by a media player application, Input 2 (graphics stream 1) represents a graphics data stream generated by a video application, Input 3 (audio stream 2) represents an audio stream for playing a ringtone generated by a telephony application (e.g., in response to an incoming call), and Input 4 (graphics stream 2) represents graphics data for displaying an alert of the incoming call, which may include supplemental information such as a caller ID. Input 1, Input 2, Input 3 and Input 4 are received at corresponding logical inputs Logic In 1, Logic In 2, Logic In 3 and Logic In 4 at the mediator 200.

As discussed above, the mediator 200 performs operations on the input data stream based on preconfigured rules. The manner in which data streams are processed may depend on the application from which the data streams are generated, but more generally, according to data type. In the example shown, audio streams entering Log In 1 and Log In 3 are processed in a first routing block 302 and the graphic streams entering Log In 2 and Log In 4 are processed in a second routing block 304. It is noted that the routing blocks do not necessarily refer to actual entities but merely illustrate the separate handling of audio and graphics data.

In the first routing block 302, the mediator 200 consults rules to determine, in a process step 306, whether other audio sources should be muted when a ringtone is received. For example, given the potential importance of receiving a phone call, the rules may specify that other sounds be turned off when a ringtone is generated by a telephony application, indicating an incoming phone call. If the rules do in fact specify muting of other sources, then in process step 308, audio stream 1 generated by the media player is blocked and prevented from being routed to an output device. If, however, muting is not mandated, both audio streams 1, 2 are passed on to the next stage where the output device to which audio streams 1, 2 are to be delivered is determined. In process step 310, the mediator 200 determines whether a headphone is present (e.g., plugged into the headphone jack port 128). The rules may provide that if a headphone is present, then the headphone is the preferred output device for audio streams. In step 312, after a headphone has been detected, the mediator routes the audio streams 1, 2 along channels directed to the headphone jack 128. Otherwise, in step 314, the mediator routes audio streams 1, 2 along channels directed to the speaker 116.

At the second routing block 304, a similar set of processes may occur with respect to graphics data streams 1, 2 due to the potential overriding nature of the input from the telephony application. In process step 316, it is decided, according to the rules, whether the alert should interrupt other streams of graphics data. If the rules provide that other graphics streams should be interrupted, graphics stream 1 generated by the video application is blocked in process step 318. Otherwise, graphics streams 1, 2 are routed to the display screen 118 in step 320.

Returning again to the progress of the audio streams 1, 2, once they have been routed, the streams may be processed further under the control of the mediator 200. Although by the time audio streams 1, 2 have been routed to an output device it has already been decided not to mute audio stream 1, the rules may still provide for highlighting the ringtone (audio stream 2) generated by the telephony application by reducing the volume of audio stream 1 in process steps 322, 324 (speaker and headphone, respectively). Whether audio stream 1 has been reduced in volume or not, audio streams 1, 2 are resampled and mixed into single audio data streams in process steps 326, 328, which are output respectively to the speaker 116 (Output 1) and headphone jack port 128 (Output 3).

With regard to graphics streams 1, 2, they are also processed prior to output at the display screen; however as graphics data does not ‘mix’ in the same way as audio data, the combining or blending of separate graphics streams can be more complex, and the rules applied by the mediator 200 as to how to process the graphics data may be more application-specific. For example, the graphical alert generated by the telephony application may consist of a small dialog box (an ‘alert box’) that only occupies a portion of the viewing screen. One option then would be to overlay the alert in a portion of the screen otherwise taken up by the video application (graphics stream 1). Even in this case there are numerous sub-options: the exact coordinates on the screen to place the alert box, whether to make the alert box removable or at least movable by the user during the telephone call, whether the display should be intermittent (e.g., blinking, appearing every 2 seconds and so on) or whether it should remain on the screen constantly. Accordingly, in process step 330, graphics streams 1, 2 may be mixed in according to the rules in a complex, application-specific manner before being output to the display screen (Output 2).

More generally, the rules that govern routing, mixing, modifying and blocking as well as volume adjustment operations by the mediator 200 may depend on both of the competing applications, and not just one. For example, in the present example, a video application may be considered lower priority than the telephony application, so that the rules may provide for a different output of the alert, with knowledge of the competing application, than might be the case with a higher priority application. In a related vein, certain classes of data may be accorded higher priority than other classes. Along the lines of the present example, among audio data types, ringtones may be given priority over general audio data, but not over generic system sounds which may provide important alerts concerning the state of the electronic device 100. The rules thus can provide a great deal of flexibility as to how data streams are to be handled.

While the description above has dealt with the routing and post-processing of output streams, similar principles apply with regard to the handling of streams initially received via an input device of the electronic device 100 such as a microphone 112 or camera and then recorded, as the mediator 200 regulates both playback and recording process according to preconfigured rules 202.

FIG. 4 is a block diagram of an exemplary software architecture implementation of the system and method of the present invention. FIG. 4 shows a software architecture stack 400 including several layers 402, 404, 410, 412 that may be loaded and executed on the processor 102. A hardware layer 414 of the software architecture stack 400 includes the input, output and I/O devices of the electronic device 100. An application layer 402 includes a plurality of applications App 1, App 2, App 3 . . . App M that generate input streams to be routed to various output devices. Below the application layer is an interface layer 404 which includes libraries 406 (e.g., call-up procedures, functions, scripts etc.) that the applications App 1, App 2, App 3 . . . App M may call-up and incorporate.

In particular, the interface layer 404 includes libraries 406 that the applications App 1, App 2, App 3 . . . App M can use to interface with a daemon 408 in a ‘daemon layer’ 410. The daemon 408 is a continually running background process in which mediator 200 according to the present invention is implemented. The daemon includes, or is linked to, the preconfigured rules that govern the operations performed by the mediator 200. Any application App 1, App 2, App 3 . . . App M which requests to playback or record a stream of data connects to the daemon 408. The daemon 408 implements the functionality of the mediator 200 discussed above, controlling routing, mixing, modifying, blocking and re-sampling (e.g., during a playback).

When delivering output streams to or receiving input steams from devices, the daemon 408 makes use of certain standard functions (e.g., Linux functions) stored in an ALSA (Advanced Linux Sound Architecture) layer 412 which includes device drivers for the input, output and I/O devices in hardware layer 414.

Communication between the application layer 402 and the daemon 408 via the interface layer 404 may employ several kinds of IPC (Inter-process Communications) procedures. A FIFO (first-in, first-out) procedure may be used to notify the daemon 408 that a storage buffer is full or empty and that data needs to be read from or written to a device. A socket procedure may be used to create an initial connection between the daemon 408 and an application App 1, App 2, App 3 . . . App M. If an application App 1, App 2, App 3, . . . App M requests the daemon 408 to change its output/input device or adjust the volume, it may notify the daemon 408 through the socket connection. When the application App 1, App 2, App 3 . . . App M completes, the application closes the socket and the connection is then released. A shared memory procedure may be used to transfer sound data quickly with low latency by using a common buffer. In addition, a semaphore procedure may be to synchronize a particular application (e.g., App 1) with the daemon 408 by ensuring that only the application App 1 or the daemon 408 can access shared memory and by blocking the application App 1 during the time in which the daemon 408 is writing to or reading from shared memory.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. In addition, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method of controlling media streams in an electronic device comprising:
receiving an input stream from each of a plurality of applications executed on the electronic device outside of an execution thread of any of the plurality of applications; and
routing each of the input streams to an output device according to a set of preconfigured rules.

2. The method of claim 1, wherein the preconfigured rules are stored in one or more tables in the electronic device.

3. The method of claim 1, wherein the routing step includes determining, for each input stream, an output device to which to route the input stream, according to the preconfigured rules.

4. The method of claim 3, further comprising:
blocking an input stream based on the presence of another of the input streams according to the preconfigured rules.

5. The method of claim 1, further comprising:
after routing, mixing an input stream with another input stream routed to the same output device.

6. The method of claim 1, wherein the input streams comprise media streams.

7. The method of claim 1, wherein the preconfigured rules differentiate between input streams based on application and content type.

8. The method of claim 7, wherein the preconfigured rules may accord a higher priority to certain applications and content types over other applications and content types.

9. The method of claim 1, wherein the receiving and routing steps are performed by a daemon that runs as a background process separately from the plurality of applications.

10. An electronic device comprising:
a plurality of output devices; and
a processor adapted to execute:
a plurality of applications, each of the plurality of applications being adapted to produce a data stream; and
a mediator coupled to each of the output devices, the mediator process being further adapted to:
receive the data streams from each of a plurality of applications and
route the data streams from the plurality of applications to one or more of the plurality of output devices according to a set of preconfigured rules.

11. The electronic device of claim 10, wherein the processor further includes one of a database or file having the set of preconfigured rules.

12. The electronic device of claim 10, wherein the mediator is further adapted to determine, for each received data stream, an output device to which to route or modify the input stream, according to the preconfigured rules.

13. The electronic device of claim 12, wherein the mediator is further adapted to modify a received data stream based on the presence of another of the received data streams according to the preconfigured rules.

14. The electronic device of claim 10, wherein the processor executes the mediator as a daemon process.

15. The electronic device of claim 10, wherein the mediator is further adapted to mix a data stream with another data stream routed to the same output device.

16. The electronic device of claim 10, wherein the data streams includes media streams.

17. The electronic device of claim 16, wherein the data streams are one of audio and graphics streams.

18. The electronic device of claim 14, wherein the plurality of applications communicate with the mediator through an interface layer executed by the processor.

19. The method of claim 1, wherein the electronic device comprises a mobile device.

20. The electronic device of claim 10, wherein the electronic device comprises a mobile device.
